(19) United States
(12) Patent Application Publication
(10) Pub. No.: US 2003/0083957 A1
(43) Pub. Date: May 1, 2003

(54) METHOD AND APPARATUS FOR SELECTION AND VIEWING REAL ESTATE PROPERTIES

(76) Inventor: SHARI B. OLEFSON, FT. LAUDERDALE, FL (US)

Correspondence Address: ALLEN M KRASS, GIFFORD KRASS GROH SPRINKLE, PATMORE ANDERSON CITKOWSKI, 280 N WOODWARD AVENUE SUITE 400, BIRMINGHAM, MI, 48009

(21) Appl. No.: 08/664,164

(22) Filed: Jun. 14, 1996

Related U.S. Application Data
(60) Provisional application No. 60/001,912, filed on Jun. 16, 1995.

(51) Int. Cl. G06F 17/60

(52) U.S. Cl. 705/27; 705/26

(57) ABSTRACT

Methods and apparatus for selecting and viewing real estate properties are disclosed which enables a buyer to conveniently “view” a real estate property without physically visiting the actual real estate property. A set of panoramic visual images is recorded for each of a plurality of real estate properties and the images are stored in a centralized computer database along with an index of selection criteria. A prospective buyer inputs, through a user terminal having input means and display means, selection criteria. A central processing unit (“CPU”) selects those real estate properties which satisfy the selection criteria. The selected properties are displayed, and the user selects for viewing one of the properties displayed. The CPU then displays the panoramic visual images stored for the selected property. The user, while viewing a panoramic visual image, may input a change perspective command, such as “look left” or “go to living room” causing the CPU to display an additional panoramic visual image in accordance with the change perspective command. The change perspective command permits the user to view the full panoramic visual representation of the real estate property.

This application claims priority from U.S. provisional application Serial No. 60/001,912 filed Jun. 16, 1995.

### BACKGROUND OF THE INVENTION

1. Field of the Invention

The present invention relates generally to real estate property selection and viewing, and more particularly to methods and apparatus for generating, selecting and viewing visual representations of real estate properties which permits a user to select a particular real estate property, view panoramic visual images of that property, and display additional panoramic visual images in response to a change perspective command, thereby enabling a user to “tour” a real estate property without physically visiting the property.

### BACKGROUND

The dominant method utilized to sell real estate is to list a property through a Multiple Listing System (“MLS”). Most real estate offices currently access the MLS central data base via in-house computer terminals with modems. Standardized information about each property includes legal description, street address, folio number, owner information, existing loan information, real estate taxes, number of bedrooms, bathrooms and other rooms and the size of same, amenities such as water frontage and/or pool, type of construction, and a photograph of the real estate property.

A buyer wishing to purchase real estate contacts a realtor who accesses the MLS to find a suitable property for the buyer. A realtor will print out the MLS information on properties the buyer may be interested in, review it with the buyer and schedule appointments to see the properties. Frequently the buyer is not interested in purchasing many of the properties viewed, and the average buyer views eight properties before making an offer. The buyer often makes this determination upon seeing the property from the street or immediately upon entering the property, as the property simply does not have the “look” or the “feel” that the buyer is seeking. The MLS system does not offer an alternative to actually taking the buyer to each property and a great deal of time is wasted as the buyer views unwanted properties.

The present invention allows realtors and their customers to save time and effort by “touring” several real estate properties from a single location which is remote from the actual properties. The realtors and customers are thereby afforded easy access to intangible information, such as the “look” or “feel” of a home that buyers cannot put into words. It also permits out-of-town or disabled buyers to conveniently view properties. While most people will still prefer to physically visit the actual real estate property before making a final decision, the present invention will eliminate a majority of the showing appointments and subsequently reduce the time and effort involved in selling and buying real estate.

### SUMMARY OF THE INVENTION

The present invention relates to methods and apparatus for generating, selecting and viewing panoramic visual representations of real estate properties. Embodiments of the invention permit a user to select, among a plurality of real estate properties, those particular properties of interest and view the panoramic visual images recorded and stored for each real estate property. Upon input of a change perspective command by the user, such as “look left” or go backward”, additional images are displayed which correspond to the changed perspective requested by the user.

The present invention solves the problems of the MLS system, which consumes much time and effort in selling or buying a real estate property, by providing a panoramic visual t our of a real estate property which permits the potential buyer to view a significant proportion of the real estate property. First, a set of panoramic visual images is recorded for each of a plurality of real estate properties to be selected and viewed. Each image is a 360° visual representation of the property as seen from the camera's perspective. The panoramic visual A images are then stored in a centralized computer data base along with an index of selection criteria, such as location and physical features of each particular property. Additionally, each real estate property is identified by a unique designation.

A user inputs, through a user terminal having input means and display means, one or more of the selection criteria. A central processing unit (“CPU”), in electrical communication with the user terminal and centralized computer database, is located remotely from the user terminals, and may be accessed via private or public networks. The CPU monitors the input means for selection criteria and selects those real estate properties which satisfy the selection criteria input by the user. The unique designations for the properties selected are displayed on the display means, informing the user which properties satisfy the input criteria.

The user may then select, using the input means, unique designation of a real estate property displayed for the purpose of viewing that property. The CPU monitors the input means for input by the user of a selection and subsequently displays the panoramic visual images stored for the selected property.

The user, while viewing a panoramic visual image, may input a “change perspective” command through the input means. The change perspective command permits the user to view the full 360° panoramic visual representation as seen from the camera's perspective. Change perspective commands include commands such as “look left” or “look up”, which may be input by moving a mouse to the left or upwards. Change perspective commands such as “zoom in” may be input by hitting an “up” arrow on a typical keyboard, or selecting a particular icon. To input a change perspective command to move to another room, a user may “click” on a “hotspot” which is positioned in a doorway which is displayed in the panoramic visual image. For example, a user may look left, look up, or look back and see the same images as would be seen if the user was standing in the camera's position. Each change perspective command may be input in a variety of ways, depending upon the command and equipment available to the user. Upon input by the user of a change command, the CPU displays an image corresponding to the image requested by the change perspective command.

Additionally, the system may display, along with each panoramic visual image, a graphical representation of the selected real estate property, such as a floor plan of a home, along with a perspective indicator positioned on the graphical representation. The indicator is indicative of the perspective A from which the panoramic visual image was recorded, and informs the user of their position on the real estate property and the direction in which the viewer is “looking.” If a user is currently displaying a room within a home, and wishes to view a room which is not visible from the current room currently being viewed, the user may input a change perspective command such as “go to kitchen” by merely clicking with a mouse or touching the display at the kitchen's location as shown on the graphical representation.

Information regarding the identification of users may be stored in the centralized database and, prior to viewing real estate properties, the CPU may request that the user enter information which identifies the user, such as a password. The CPU will then determine if the information input by the user matches user identification information stored within the centralized database. Upon determining that the user has entered the appropriate information, the user will be permitted further access to the centralized database and allowed to view panoramic visual images for a variety of real estate properties. This feature prevents unlimited access to the panoramic visual images, and functions as a security measure to prevent and discourage unwanted intrusions.

The sequence in which the panoramic visual images are displayed may mimic the sequence of an in-person real estate tour of an actual real estate property. First, the neighborhood within which the property is located is viewed. Upon arriving at the property, the property is viewed from a street access. If the real estate property includes a home, the front exterior of the home is viewed. Next, the entryway, the general living areas such as the living room and kitchen, and bedrooms of the home are viewed. Lesser rooms of the home are then viewed, such as bathrooms and utility areas. Nearing the end of the tour, the rear of the property is viewed from the home, and finally the rear exterior of the home is viewed.

The panoramic visual images may be recorded utilizing processes and technologies which enable the panoramic visual images to be perceived stereoscopically. If stereoscopic images are being viewed, virtual reality goggles and gloves may be utilized as display means and input means.

An audio accompaniment describing each panoramic visual image may be recorded and played, through speakers positioned near the display means, such that, as each panoramic visual image is displayed, the audio accompaniment describing the panoramic visual image is played.

A “questions and comments” form is displayed on the display means at the end of the “tour”, which gives the user an opportunity to provide feedback or request additional assistance.

Additionally, the system may provide a financial analysis, dependent upon input of particular financial information into the system from the user, enabling the user to do a preliminary analysis of the financial requirements of acquiring the real estate property. Information such as purchase price, down payment, interest rate and terms may be input by the user. The central processing unit would then calculate, based upon the financial information input by the user, an estimated monthly mortgage payment and display the calculated monthly mortgage payment on the display means. Many variations of this financial calculation are possible within the present invention, such as inputting a maximum monthly mortgage payment and down payment and interest rate, and calculating a purchase price. Appraisals and other financial information which is available for the property may be stored in the database and made available and displayed to the viewer at this time.

Other objects, advantages and applications of the present invention will be made clear by the following detailed description of a preferred embodiment of the invention. The description makes reference to drawings in which:

### BRIEF DESCRIPTION OF THE DRAWINGS

FIG. 1 is a pictorial representation of the preferred embodiment of the apparatus of the present invention;

FIG. 2 is a view of a displayed panoramic visual image where a graphical representation of the house is depicted with the user's perspective indicated on the graphical representation;

FIG. 3 is a preferred embodiment of the questions and comments form displayed to the user at the end of the “tour”;

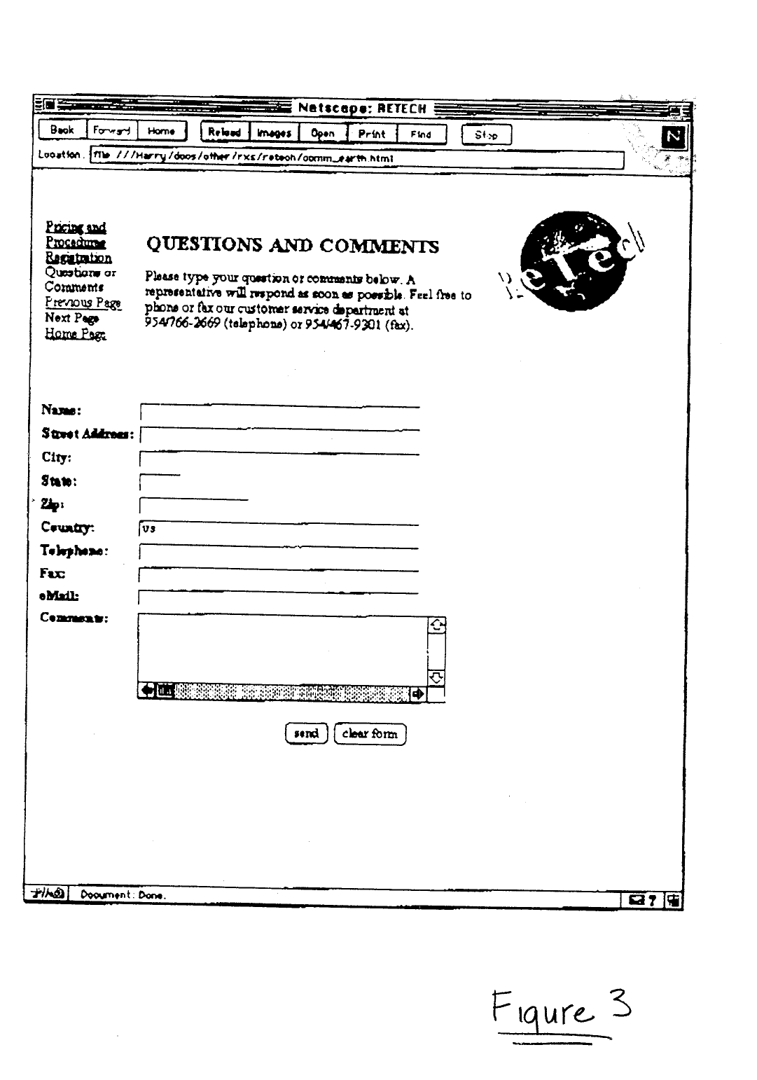

FIG. 4 is a pictorial representation of the preferred apparatus for creating the panoramic visual images; and

FIG. 5 is a flowchart of the preferred method of the present invention.

### DETAILED DESCRIPTION OF A PREFERRED EMBODIMENT OF THE PRESENT INVENTION

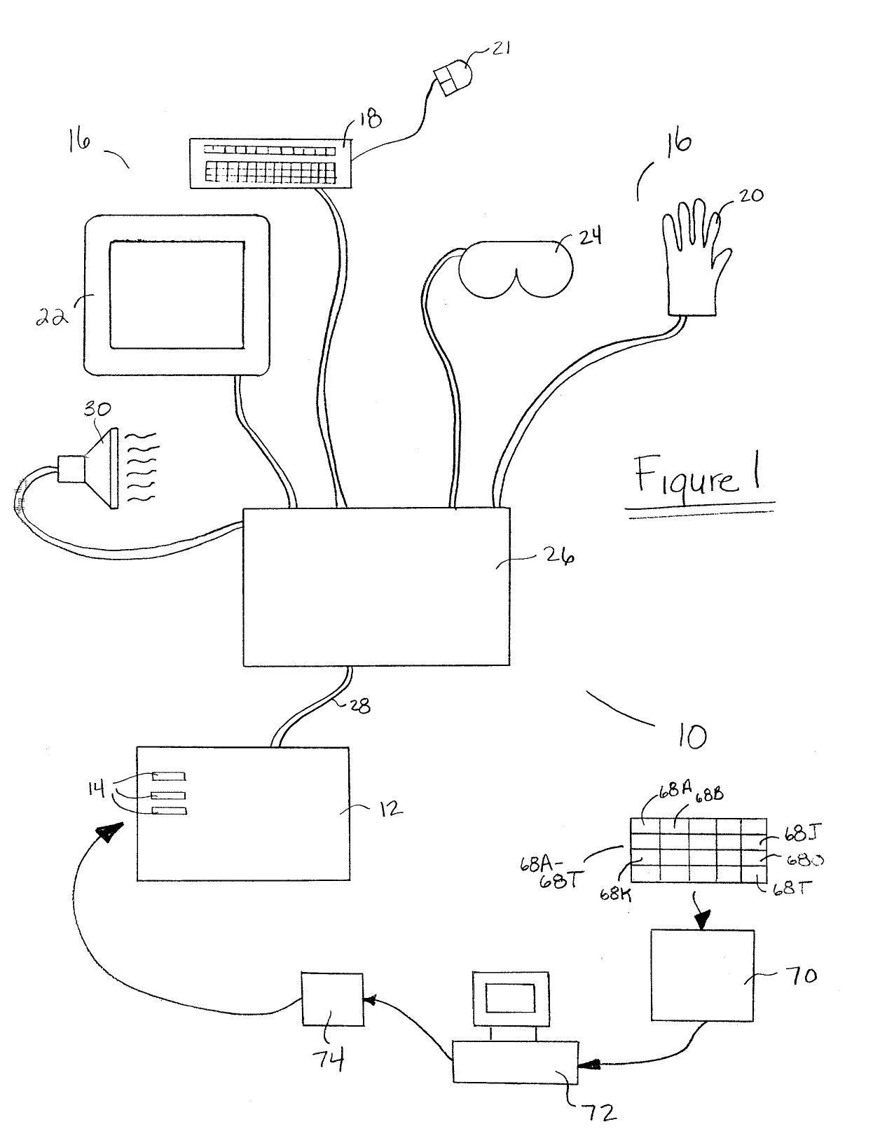

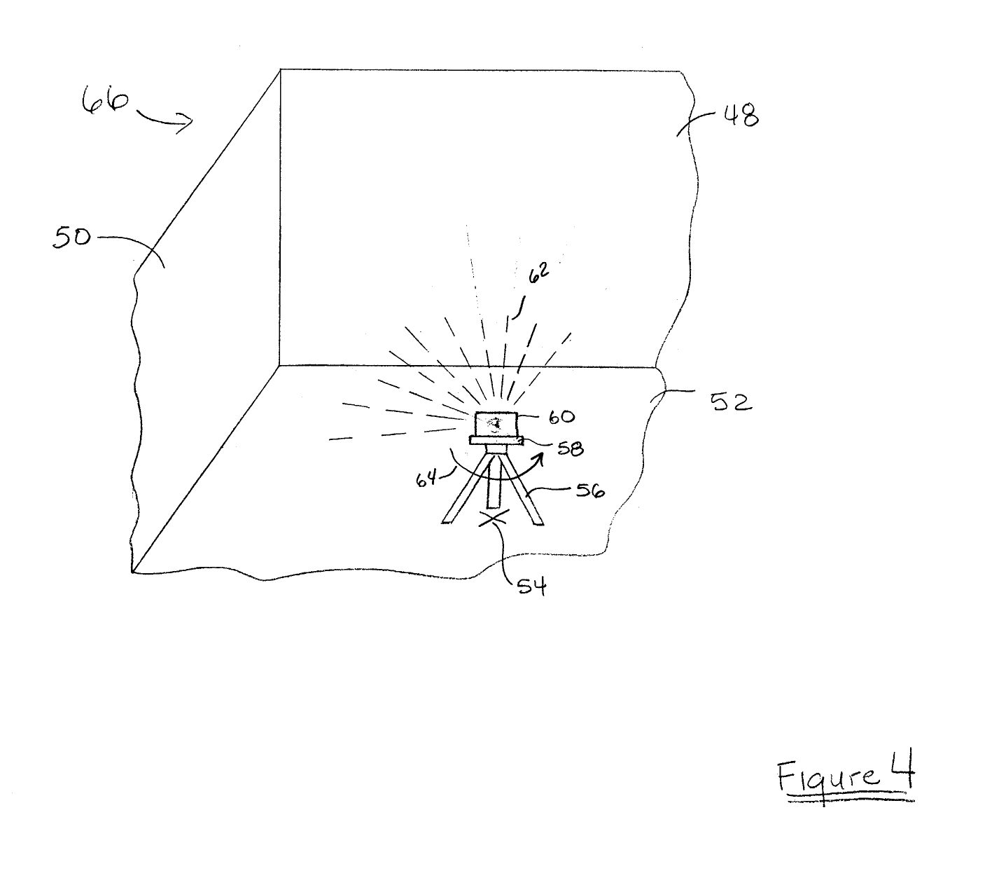

A preferred embodiment of the present invention is shown generally at 10 in FIG. 1. The system 10 includes a centralized computer database 12 having at least 48M of RAM and an operating speed of at least 132 Mhz. The data base may be configured to permit duplication and distribution of the data base, such as via compact disk. Stored within database 12 is a set of panoramic visual images 14, a set 14 for each of a plurality of real estate properties. Each panoramic visual image has been recorded from a particular perspective or camera position on the property. For example, if the real estate property includes a home, panoramic visual images may be taken from a perspective within each room, within each hallway, and panoramic visual images of the exterior of the home may be taken from a perspective on the street and in the middle of the backyard of the home. As depicted in FIG. 4, position 54 represents the perspective of the camera 60.

The panoramic visual images recorded for each real estate property will provide a 360° panoramic “tour” of the property. The panoramic visual images may be created in a variety of ways, the preferred embodiment being depicted in FIG. 4, which shows a portion of a room 66 having a rear wall 48, a left wall 50, and a floor 52. A 35 mm camera 60 having a wide angle lens (not shown) is mounted on rotating bracket 58, which is rotatably mounted to tripod 56. Bracket 58 enables camera 60 to be rotated on tripod 56 and ensures stability, levelness and consistency of angles at which the images are taken. A commercially available bracket such as “QuickPan” is preferably used in the present invention. Camera 60 is rotated in the direction of arrow 64 at a standard increment of degrees, such as 10, 15, or 28° after recording an image until a series of photographs encompassing a full 360° are taken. Alternate embodiments may utilize a stepper motor in place of bracket 58 or utilize a rotatable tripod to automatically rotate the camera.

In the preferred embodiment, the images are recorded during dusk or dawn, and all lights within a home are illuminated to provide optimum lighting conditions.

In the preferred embodiment, the film from the camera is developed into a series of images, depicted in FIG. 1 as 68A-68T. A scanner 70, such as a Nikon or other commercially available scanner, is utilized to digitize the images 68A-T, which are subsequently stored on a development computer 72, which is preferably a Radius 601/110 MHZ having 48M of RAM, 2G of data storage and a 17″ color monitor.

In alternative embodiments, a digital camera may be used and the images developed directly onto a compact disk which is subsequently loaded on development computer 72 using software such as Adobe Photoshop.

In the preferred embodiment, software such as Adobe Photoshop is utilized to manipulate and color-correct the images to produce suitable, panoramic visual images of the real estate property by removing undesired imperfections, adjusting lighting levels and making additional modifications to the photographs rendering them clearer, cleaner, and providing a more consistent panoramic visual image. The preferred embodiment also utilizes a debabelizer to reduce the color pallet across all photographs which will be stitched into a single panoramic visual image, thereby reducing the file size and increasing visibility and clarity of the image.

The images on computer 72 are then ‘stitched’ together to create a single panoramic visual image. A variety of software programs, such as Apple QuickTime VR Authoring Tools and MPW Tools, which are utilized in the preferred embodiment of the present invention are available to “stitch” the images together to create a 360° panoramic visual image.

In an alternate embodiment, a panoramic camera may be utilized to record the images which may then be digitized, eliminating the need to ‘stitch’ images together to create a single panoramic visual image.

In the preferred embodiment, the panoramic visual images are arranged in sets 14 and downloaded to an external storage device 74 which enables the set of panoramic visual images 14 to be transferred to centralized computer database 12. The preferred embodiment utilizes a Syquest EZ135 with multiple cartridges as an external storage device. In alternate embodiments, the computer 72 may be in electrical communication with database 12 such that the sets of panoramic visual images 14 may be downloaded directly into database 12, without use of external storage medium.

Another alternate embodiment of the invention utilizes stereoscopic or three-dimensional images, which are produced by recording two images, a “left” image corresponding to the view as seen by a user's left eye, and a “right” image corresponding to the view as seen by a user's right eye. When the “right” image is displayed to the right eye, and the “left” image is displayed to the left eye, the images are perceived stereoscopically. The images are displayed to the respective eyes through goggles, thereby permitting the user to view the panoramic visual images stereoscopically. Alternatively, the images may be viewed stereoscopically through glasses having a left lens which permits the left eye to view only the left image, and having a right lens which permits the right eye to view only the right image.

Also stored within database 12 are selection criteria which describe each real estate property. Selection criteria are those aspects of a given property that are important to a buyer in a purchasing selection, such as price, square footage, number of bedrooms, lot size, and county and school district within which the property is located. A unique designation is provided for each property and stored in database 12 which permits users to easily identify, select and view a particular property. In a preferred embodiment, an alphanumeric code is utilized as the unique designation. In alternate embodiments, a name, icon such as a picture of the front of the home, number or the street address may be utilized as the unique designation.

A centralized processing unit (“CPU”) 26 is in electrical communication via cable 28 with database 12. In the preferred embodiment of the present invention, a server is utilized as CPU 26 and database 12, which permits a multitude of users to access the sets of panoramic visual images 14 simultaneously. Preferably, a server such as a SUN upgradeable server is utilized having 16M with an additional 32M RAM and having an operating speed of 132 Mhz.

A user terminal 16, also in electrical communication with CPU 26, has input means such as a standard keyboard 18, mouse 21 or voice activation means (not shown). User terminal 16 also has display means, such as screen 22. If screen 22 incorporates “touch screen” technology, screen 22 may be utilized as both input and display means. If the panoramic visual images were created so as to enable stereoscopic viewing, goggles 22 may be utilized to display the stereoscopic images, and glove 20 may be utilized as input means.

Using the input means, a user may input a “change perspective” command, which causes CPU 26 to display an additional image which corresponds to the new perspective requested by the user. The preferred embodiment includes change perspective commands such as look left, look right, look forward, look behind, look up, look down, zoom in and zoom out, as well as commands such as go to kitchen, go to living room, go to front yard, go to rear yard, and go to master bedroom. Change perspective commands enable a user to “look around” a room within a home and move into other rooms of the home. If the user inputs a change perspective command such as “look left,” an additional portion of the currently displayed panoramic visual image is displayed. If the user is viewing a panoramic visual image of the exterior of the home, and inputs a change perspective command such as “move to kitchen,” the panoramic visual image which corresponds to the kitchen will be displayed.

In the preferred embodiment, change perspective commands such as “look left” or “look right” may be input by moving a mouse to the left or right. Change perspective commands such as “zoom in” or “zoom out” are input utilizing the up and down arrow keys on a keyboard. Change perspective commands such as “move to kitchen” are input by clicking on the kitchen as displayed on the graphical representation of the floor plan or, if the currently displayed visual image shows a door which leads to the kitchen, the door or a “hotspot” on the door may be clicked on or touched. Alternatively, icons may be presented to the user which represent various change perspective commands. Clearly, each change perspective command may be input in a variety of ways which are acceptable in the present invention.

To select a subset of the real estate properties within database 12 for viewing, the user inputs, via input means such as keyboard 18 or mouse 21, the selection criteria of interest to the user. The input process may be menu-driven by providing a user with a plurality of choices among various options within a criteria group, such as price ranges. In a preferred embodiment, the options are presented in a menu format and are selected utilizing keyboard 18 or mouse 21. If the images are viewable stereoscopically, glove 20 may be utilized as input means.

CPU 26 is programmed to monitor the selection criteria input and select those real estate properties and sets 14 of accompanying panoramic visual images which satisfy the input criteria. CPU 26 displays the unique designation of each property which has been selected on display screen 22 or goggles 24. The user then selects for viewing, utilizing keyboard 18 or gloves 20, the unique designation of a particular real estate property among those displayed. CPU 26 displays, on display screen 22 or goggles 24, the panoramic visual images of the selected real estate property.

The user then may input a change perspective command such as “look right” “look up” or “go to kitchen” which permits the user to alter the perspective from which they are perceiving the home or property. In the embodiment utilizing display screen 22, a user may type an appropriate command into keyboard 18 or move mouse 21 to select the icon of a particular change perspective command. In the embodiment which provides a stereoscopic view to the user, the user may simply move their head while wearing the virtual reality goggles 24 to input some of the change perspective commands, such as “look left,” and may use glove 20 to input other change perspective commands, such as “go to kitchen.”

In the preferred embodiment, the panoramic visual images for real estate locations upon which a home is situated are displayed in a standardized sequence. After selection for viewing, a property is introduced by displaying a map showing the physical location of the property relative to landmarks such as freeways and buildings. Next, panoramic visual images of A the neighborhood in which the real estate property is located are displayed. A panoramic visual image of the real estate property as viewed from the street is then displayed. Next, a panoramic visual image of the exterior of the home as A positioned on the real estate property is displayed. A panoramic visual image of the entryway of the home is then displayed. Subsequently, images of the general living areas of the home, bedrooms of the home, and lesser rooms of the home such as bathroom and utility areas are displayed. A panoramic visual image of the rear yard as viewed from the home as displayed, and a panoramic visual image of the rear exterior of the home is the last displayed image. Within each panoramic visual image, the user may input change view commands to permit a full 360° view of a given room as filmed from the viewpoint of the camera.

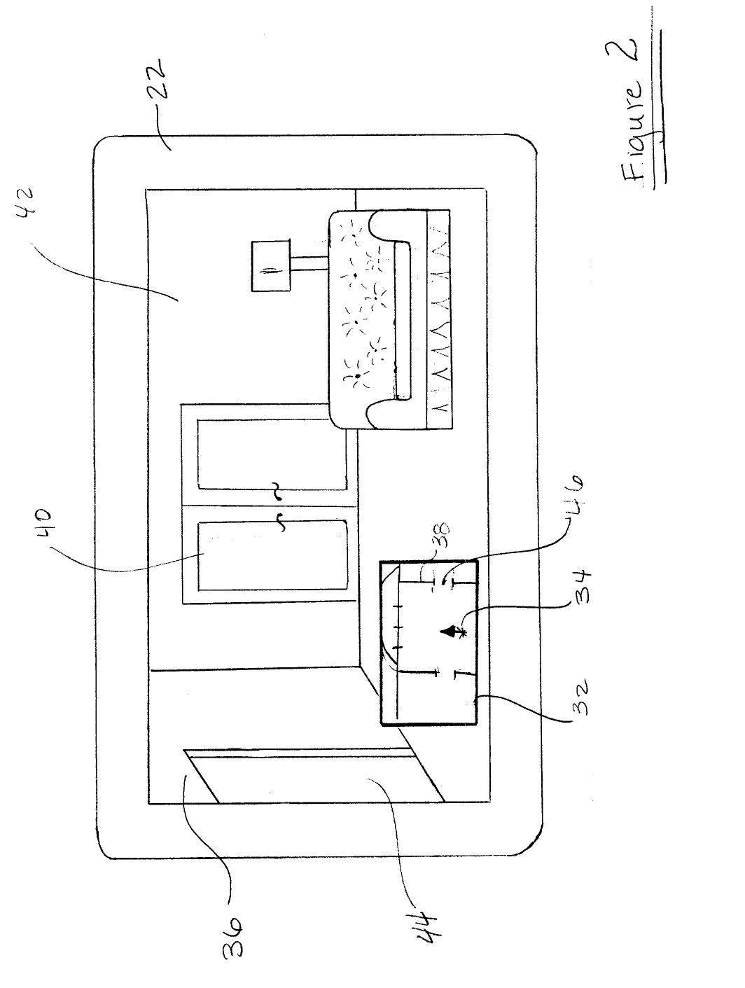

In a preferred embodiment, a graphical representation 32 of the layout of a real estate property is presented along with the panoramic visual images. If a home is included in the property, a floor plan of the home will be utilized in the graphical representation 32. The preferred embodiment depicted in FIG. 2 shows a portion 36 of a panoramic visual image on display screen 22, with graphical representation 30 shown in the lower left corner of screen 22. in alternate embodiments, be positioned elsewhere on display 22. Floor plan 38 is utilized in graphical representation 30. The indicator 32 shows the user their position within the home, and which direction within the home they are facing. Indicator 32 reflects the position of the camera and direction the camera was facing when the particular image being viewed by the user was recorded. If a home having two floors is being viewed, an icon may be displayed which, when clicked or touched, displays a panoramic visual image of the floor not currently being viewed. In larger homes, an icon may be made available for each floor present in the home. Alternatively, keystrokes such as depressing the “shift” key and hitting an “up arrow” key may be utilized to move between floors of a home being viewed.

As shown in FIG. 2, the user is looking toward the doors 40 on the rear wall 42. An exit 44 is positioned on the user's left, and, to the right of the user is exit 46 which is not displayed in the portion 36 of the panoramic visual image on screen 22. Exit 46 is shown on floor plan 38, so that the user clearly understands their position within the home and the surrounding features which are not currently displayed on screen 22. As shown in FIG. 2, the camera was positioned where indicator 32 is positioned within that room of the home, and was facing rear wall 42 when the portion 36 of the panoramic visual image was recorded.

Additionally, a preferred embodiment includes an audio recording of a message the user will hear upon entering a particular room. As the user views any given panoramic visual image, an audio recording heard via speaker 30 will describe the image the user sees. For example a panoramic visual image displaying a unique aspect of the home, such as a hand-carved fireplace, may inform the user of the date the fireplace was carved and the carver's name. Structural features of the home may be communicated to the user in this fashion, thereby obviating the need for additional written materials to supplement the view of the home.

The preferred embodiments of the present invention tracks which properties are viewed and the user who views each property. Information regarding which properties a user has viewed may be stored and transmitted to the individuals who have listed the property by placing it within the centralized database 12. This permits sellers to monitor which prospective buyers have viewed the home, as well as provide security for sellers. The preferred embodiment will record the number of times a property is viewed.

The user will be asked to complete a feedback form asking for questions and comments. In the preferred embodiment, notification of the seller will automatically occurvia a computer-generated e-mail message which may include the dates and times of “tours” and the number of “tours” taken, buyer name, realtor name and feedback on the property.

In the preferred embodiment the user may request they be provided with a printout and graphic information about the properties.

In an alternate embodiment of the invention, a financial calculation may be made giving the prospective buyer an opportunity immediately after or during the viewing of a set of panoramic visual images, to determine potential offers, corresponding mortgage payments, and other financial information necessary to determine an appropriate offering price. A worksheet, which may be stored in the centralized data base 12, may be displayed on the display means. The user may input information regarding a prospective offer to purchase the real estate viewed, as well as mortgage term, interest rates and down payment. CPU 26 will then process the financial information and display to the user the mortgage payment corresponding to the proposed offer. Alternatively, a mortgage payment may be input and the corresponding offer price may be displayed to the user. In the preferred embodiment, additional financial data may be made available to the user, such as appraisals. This permits the user to view, immediately after viewing the panoramic visual images, the data relevant to purchasing the property.

In the preferred embodiment of the invention, the user accesses CPU 26 via a network such as the World Wide Web. Centralized data base 12 will disseminate information via the World Wide Web or other network to input and display means such as personal computers located in homes, real estate offices, or public locations such as kiosks in a mall or public libraries. In the preferred embodiment, a user may access any of a variety of sites describing real estate for sale, including a site which offers the panoramic visual tours of the present invention. Real estate properties offered for sale which have been listed mother sites and for which panoramic visual tours of the present invention are available will be distinguished by a unique icon, such as a unique arrangement of letters or numbers such as “TOUR” or “360°,” or a graphic such as a person walking. The user merely clicks on the icon and is hyper linked to the site which offers the panoramic visual tours of the present invention. The user will be greeted by a welcome page and a request to input information about the user. The user will, in the preferred embodiment, download the QuickTime VR software necessary to run the panoramic visual tours if the user does not already have the software available. If alternate software is utilized to create the panoramic visual images, then the alternate software will be downloaded if necessary. Once the appropriate software is downloaded, the user selects the real estate properties to be viewed by entering the unique designation of those properties. The user may then view the panoramic visual images.

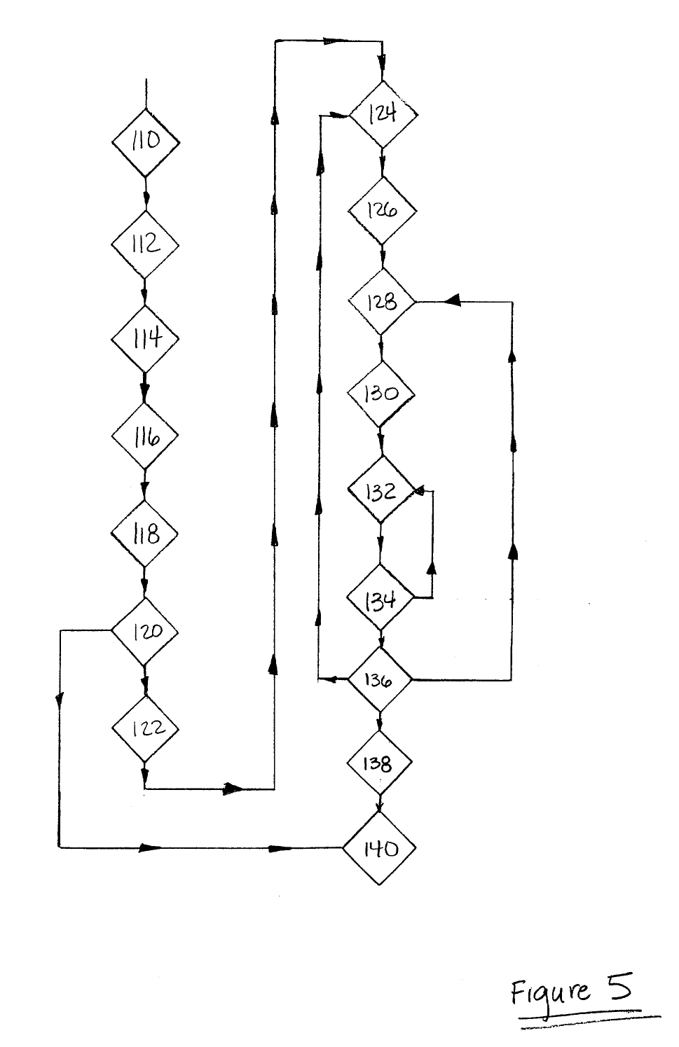

The preferred embodiment of the method of the present invention is disclosed in the flowchart of FIG. 5. In step 110, a set of panoramic visual images for each of a plurality of real estate properties is created. Each panoramic visual image is created as disclosed above and in FIGS. 1 and 4. In step 112, each real estate property is given a unique designation so that particular properties may be selected for viewing. Set 114 includes storing, in a centralized database, the panoramic visual images and the unique designations along with an index of selection criteria describing each real estate property. In the preferred embodiment, the selection criteria include lot size, geographic location and physical characteristics of structures situated on the property. At step 114, information identifying users such as name, address, and affiliation with specific real estate agents will also be stored in the database. In step 116, a user accesses a CPU via a user terminal which is in electrical communication with the database and the CPU. The user terminal comprises a keyboard, mouse or other input means, as well as a device for displaying the panoramic visual images, such as a commercially available computer monitor.

Once the user has accessed the CPU, the user, in step 118, is asked to input information identifying the user. The user inputs the appropriate information in step 120 such as a password or name of an approved user, their own name or affiliation with a real estate agent. In step 122 the CPU matches the information input by the user with the information stored the database in step 114. If the information matches, the user proceeds to step 124, where the selection criteria are entered which enables the user to search the real estate properties in the database for those properties satisfying the user's particular criteria. If the information does not match, the user is not permitted to access the real estate properties located in the database, and proceeds to exit via step 140.

In set 126, the unique designations for the real estate properties matching the user's selection criteria input in step 124 are displayed. If the user does not see any properties to their liking, they may return to step 124. If the user sees a property designation that is of interest, the user selects, in step 128, the unique designation for the real estate property to be viewed. In alternate embodiments, steps 118, 120 and 122 which limit access to a select group of users may be moved to a position after step 128, and require input and matching of user information only for selected properties. This allows those individuals who wish to permit all members of the public to access their real estate “tour” while maintaining precautionary screening of users for those who wish to restrict viewing of their properties.

The first panoramic visual image of the selected real estate property is displayed on the monitor in step 130. In step 132, the user inputs a change perspective command, such as “look right” or “go to kitchen”. The change perspective commands may be input in a variety of ways, including utilizing a mouse, touch screen, key strokes or voice activation. An additional panoramic visual image is displayed in step 134 in accordance with the change perspective command. If the change perspective command is “look left”, an additional portion of the currently displayed panoramic visual image is displayed. If the user is viewing a panoramic visual image of the living room and inputs the change perspective command “go to master bedroom”, the panoramic visual image which corresponds to the master bedroom is displayed. If the user inputs a “look left” command, the image which shows what is to the left of the user is displayed.

As seen from FIG. 5, step 134 may lead back to step 132, wherein the user inputs additional change perspective commands to the real estate property selected. When the user has finished viewing the panoramic visual images of a particular real estate property and wishes to view another property, the user exits to step 136, which provides the user with an opportunity to perform some of financial calculations such as those detailed above involved in determining whether or not a particular real estate property is affordable.

After the user has either completed the financial calculations or has chosen to skip all calculations, the user may exit step 136 and return to step 126 which displays the unique designations of real estate properties selected in accordance with the selection criteria input in step 124.

If the user wishes to perform a new search utilizing revised criteria, the user returns to step 124 and inputs the revised selection criteria. If the user has completed touring real estate properties and wishes to exit, the user exits to step 140.

Having described the various embodiments of the present invention with reference to the accompanying figures, it will be appreciated that various changes and modifications can be made without departing from the scope or spirit of the invention.

1. A method of generating visual representations of a real estate property enabling a user to select and view particular representations thereof, comprising the steps of:
recording a set of panoramic visual images for each of a plurality of real estate properties to be selected and viewed, each panoramic visual image being recorded from a particular perspective and each real estate property being identified by a unique designation;
storing the sets of panoramic/visual images and accompanying unique designations in a centralized computer database along with an index of selection criteria, such criteria including the geographical location and physical features of each real estate property;
providing a user terminal having input means and a display device, the user terminal remote from and in electrical communication with the centralized computer database;
entering, through the input means of the user terminal, one or more of the criteria;
displaying the unique designations of the real estate properties indexed to the entered criteria;
selecting, through the input means, one of the properties indexed to the entered criteria for the purpose of viewing that property;
displaying one of the panoramic visual images stored for the selected property on the display device;
receiving a change perspective command through the input means of the user terminal; and
displaying an additional panoramic visual image for the selected property in accordance with the change perspective command.

2. The method claim 1, further comprising the step of displaying, along with each panoramic visual image, a graphical representation of the selected real estate property along with a perspective indicator positioned on the graphical representation indicative of the perspective from which the panoramic visual image was recorded.

3. The method of claim 1, wherein the graphical representation of the selected real estate property is a map of the real estate property.

4. The method of claim 2, wherein the perspective indicator is an arrow.

5. The method of claim 1 wherein the steps of entering, through the input means of the user terminal, further comprises the steps of:
storing, in the centralized database, user identification;
entering, through the input means of the user terminal, information which identifies the user;
determining if the inputted information which identifies the user matches the user identification stored within the centralized database; and
permitting further access to the centralized database if the inputted information which identifies the user matches the user identification stored within the centralized database.

6. The method of claim 5 wherein the step of entering, through the input means of the user terminal, further comprises entering a password.

7. The method of claim 1 wherein the change perspective commands consist of: move forward, move backward, move left, move right, look forward, look left, look right, look behind, and look up.

8. The method of claim 1, further comprising the steps of:
recording an audio accompaniment describing each panoramic visual image recorded; and
playing the audio accompaniment as each panoramic visual image is displayed.

9. The method of claim 1, wherein the step of recording a set of panoramic visual images for each of a plurality of real estate properties further comprises recording the panoramic visual images so that they are perceived stereoscopically.

10. The method of claim 1, further comprising the steps of:
storing, in the centralized database, a financial worksheet;
entering, through the input means, financial data such as down payment, purchase price, and interest rate onto the financial worksheet;
calculating, based upon the financial information input, an estimated monthly mortgage payment for the real estate property being viewed; and
displaying the calculated monthly mortgage payment on the display means.

11. A method of generating visual representations of a home enabling user to select and view particular representations thereof, comprising the steps of:
recording a set of panoramic visual images for each of a plurality of homes to be selected and viewed, each panoramic visual image being recorded from a particular perspective and each home being identified by a unique on;
storing the sets of panoramic visual images and accompanying unique designations in a centralized computer database along with an index of selection criteria, such criteria including the geographical location and physical features of each home;
providing a user terminal having input means and a display device, the user terminal remote from and in electrical communication with the centralized computer database;
entering, through the input means of the user terminal, one or more of the criteria;
displaying the unique designations of the homes indexed to the entered criteria;
selecting, through the input means, one of the homes indexed to the entered criteria for the purpose of viewing that home;
displaying one of the panoramic visual images stored for the selected home on the display device;
receiving a change perspective command through the input means of the user terminal; and
displaying an additional panoramic visual image for the selected home in accordance with the change perspective command.

12. The method of claim 11 wherein the change perspective commands further consist of: go to kitchen, go to living room, go to laundry room, go to first bedroom, go to second bedroom, go to third bedroom, go to utility room, go to first bathroom, go to second bathroom, go upstairs, go downstairs.

13. The method of claim 11 wherein the step of displaying one of the panoramic visual images stored for the selected home on the display device further comprises displaying the panoramic visual images in the following sequence:
displaying a panoramic visual image of the home as viewed from a street access;
displaying a panoramic visual image of the front exterior of the home;
displaying a panoramic visual image of the entryway of the home;
displaying panoramic visual images of the general living areas such as the living room and kitchen of the home;
displaying panoramic visual images of the bedroom areas of the home;
displaying panoramic visual images of the lesser rooms of the home, such as bathrooms and utility areas of the home;
displaying a panoramic visual image of the rear yard as viewed from the home; and
displaying a panoramic visual image of the rear exterior of the home.

14. The method of claim 11, further comprising the step of displaying, along with each panoramic visual image, a graphical representation of the selected home along with a perspective indicator positioned on the graphical representation indicative of the perspective from which the panoramic visual image was recorded.

15. The method of claim 13, wherein the graphical representation is a floor plan of the home.

16. The method of claim 11, wherein the perspective indicator is an arrow.

17. A virtual reality real estate viewing system for allowing a user to visualize a real estate property, the system comprising:
a centralized computer database having stored therein:
a set of panoramic visual images for a plurality of real estate properties, each panoramic visual image being recorded from a particular perspective, a unique designation by which each real estate property is identified, and an index of selection criteria of each real estate property, including the geographic location and physical features of each real estate property;
a user terminal having
input means for entering information such as real estate property designations, criteria and a change perspective command, and
display means for displaying the information and panoramic visual images; and
a centralized processing unit in electronic communication with the user terminal and the centralized computer database, the centralized processing unit being programmed to perform the following functions:
monitor the input means for selection criteria,
select those real estate properties and accompanying panoramic visual images satisfying the criteria,
display information representative of the real estate properties indexed to the/entered criteria,
monitor the input means for input which selects a particular real estate property and accompanying set of panoramic visual images,
display the selected panoramic visual image on the display means, and, display, upon input by the user of a change perspective command, an additional panoramic visual image corresponding to the change perspective command.

18. The virtual reality real estate viewing system of claim 17, wherein the centralized processing unit is further programmed to display, along with each panoramic visual image a graphical representation of the selected real estate property along with a perspective indicator positioned on the graphical representation indicative of the perspective from which the panoramic visual image was recorded.

19. The virtual reality real estate viewing system of claim 17, wherein the graphical representation of the selected real estate property is a map of the real estate property.

20. The virtual reality real estate viewing system of claim 17, wherein the perspective indicator is an arrow.

21. The virtual reality real estate viewing system of claim 17, further comprising information which identifies the user stored within the centralized computer database, the centralized processing unit being programmed to first perform the following steps:
monitor the input means for inputted information which identifies the user; determine if the inputted information which identifies the user matches the stored information which identifies the user; and
upon determining that the inputted information which identifies the user matches the stored information, the user further access to the panoramic visual images stored in the centralized database.

22. The virtual reality real estate viewing system of claim 17, further comprising
an audio accompaniment for each panoramic visual image, the audio accompaniment describing the panoramic visual image;
an audio reproduction system in electronic communication with the centralized processing unit; and
the centralized processing unit further programmed such that, as each panoramic visual image is displayed, the appropriate audio accompaniment is played on the audio reproduction system.

23. The virtual reality real estate viewing system of claim 22, wherein the audio accompaniments are stored within the centralized computer database.

24. The virtual reality real estate viewing system of claim 17, wherein the images stored within the centralized database are recorded so that the images are perceived stereoscopically.

25. The virtual reality real estate viewing system of claim 24, wherein the display means includes virtual reality goggles.

26. The virtual reality real estate viewing system of claim 24, wherein the input means includes virtual reality gloves.

27. The virtual reality real estate viewing system of claim 17, wherein a financial worksheet is further stored within the centralized computer database, and the database further performs the following functions:
monitoring the input means for financial data such as down payment, purchase price, and interest rate onto the financial worksheet;
calculating, based upon the financial information input, an estimated monthly mortgage payment for the real estate property being viewed; and
displaying the calculated monthly mortgage payment on the display means.

28. A virtual reality re estate viewing system for allowing a user to visualize a home, the system comprising:
a centralized computer database having stored therein:
a set of panoramic visual images for a plurality of homes, each panoramic visual image being recorded from a particular perspective, a unique designation by which each home is identified, and an index of selection criteria of each home, including the geographic location and physical features of each home;
a user terminal having
input means for entering information such as home designations, criteria and a change perspective command, an
display means for displaying the formation and panoramic visual images; and
a centralized processing unit in electronic communication with the user terminal and the centralized computer database, the centralized processing unit being programmed to perform the following functions:
monitor the input means for selection criteria,
select those home and accompanying panoramic visual images satisfying the criteria,
display information representative of the real estate properties indexed to the entered criteria,
monitor the input means for input which selects a particular real estate property and accompanying set of panoramic visual images,
display the selected panoramic visual image on the display means, and, upon input by the user of a change perspective command, display an additional panoramic visual image corresponding to the change perspective command.

29. The virtual reality real estate viewing system of claim 28, wherein the centralized processing unit is further programmed to display, along with each panoramic visual image, a graphical representation of the selected home along with a perspective indicator positioned on the graphical representation indicative of the perspective from which the panoramic visual image was recorded

30. The virtual reality real estate viewing system of claim 28, wherein the graphical representation is a floor plan of the home.

31. The virtual reality real estate viewing system of claim 28, wherein the set of panoramic visual images for each home is arranged such that
the first image displayed is a panoramic visual image of the home as viewed from the street,
the next image displayed is a panoramic visual image of the exterior of the home,
the next image displayed is a panoramic visual image of the entryway of the home,
the next images displayed are of the general living areas such as the kitchen and living room of the home,
the next panoramic visual images displayed are of the bedrooms of the home,
the next panoramic visual images displayed are of the lesser rooms of the home, such as bathrooms and utility areas,
the next panoramic visual image displayed is of the rear property as viewed from the home, and
the last panoramic visual image displayed is of the rear exterior of the home.
